(19) United States
(12) Patent Application Publication
(10) Pub. No.: US 2024/0142097 A1
(43) Pub. Date: May 2, 2024

(54) LIGHT SOURCE SYSTEM AND DISPLAY DEVICE

(71) Applicant: Himax Display, Inc., Tainan City (TW)

(72) Inventors: Biing-Seng Wu, Tainan City (TW); Kuan-Hsu Fan-Chiang, Tainan City (TW)

(73) Assignee: Himax Display, Inc., Tainan City (TW)

(21) Appl. No.: 17/973,546

(22) Filed: Oct. 26, 2022

(51) Int. Cl. F21V 29/54; F21V 23/00; G02B 27/48

(52) U.S. Cl. CPC F21V 29/54; F21V 23/003; G02B 27/48; F21Y 2113/10

(57) ABSTRACT

A light source system configured to provide an illumination beam and including at least one light source module is provided. Each of light source module is configured to emit a color beam and includes a plurality of light sources. Different light sources are configured to emit excitation lights of different wavelengths. The excitation lights are combined to form the color beam. The at least one color beam is combined to form the illumination beam. Differences in the wavelengths fall within a range of 5 nm to 10 nm.

### BACKGROUND

### Technical Field

The disclosure relates to an optical system and an optical device, in particular, to a light source system and a display device.

### Description of Related Art

Holographic displays using laser as the light source suffer the so-called “speckling” issue, which degrade the image quality. De-speckling approaches using mechanical parts in the common laser-based projectors, such as vibration mirrors or rotational diffusers are not likely to be used for the automobile applications due to the reliability concern.

### SUMMARY

Accordingly, the invention is directed to a light source system and a display device using the light source system, which could reduce the speckling issue and have better reliability.

According to an embodiment of the invention, a light source system configured to provide an illumination beam and including at least one light source module is provided. Each of light source module is configured to emit a color beam and includes a plurality of light sources. Different light sources are configured to emit excitation lights of different wavelengths. The excitation lights are combined to form the color beam. The at least one color beam is combined to form the illumination beam. Differences in the wavelengths fall within a range of 5 nm to 10 nm.

According to an embodiment of the invention, a display device including a light source system and a light valve is provided. The light source system is configured to provide an illumination beam. The light valve is disposed in a transmission path of the illumination beam and is configured to transform the illumination beam to an image beam. The light source system includes at least one light source module. Each of light source module is configured to emit a color beam and includes a plurality of light sources. Different light sources are configured to emit excitation lights of different wavelengths. The excitation lights are combined to form the color beam. The at least one color beam is combined to form the illumination beam. Differences in the wavelengths fall within a range of 5 nm to 10 nm.

Based on the above, in an embodiment of the disclosure, the light source system and the display device using the light source system includes a plurality of light sources, different light sources are configured to emit excitation lights of different wavelengths, and differences in the wavelengths fall within a range of 5 nm to 10 nm. Since, the wavelength of each excitation light has slightly difference to each other and different wavelengths of excitation lights will generate different speckle patterns, the speckling effect of the combined color beam will be reduced.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of a display device according to an embodiment of the disclosure.

FIG. 2 is a schematic view of a light source system according to a first embodiment of the disclosure.

FIG. 3A is a schematic view of a light source system according to a second embodiment of the disclosure.

FIG. 3B is an example of a driving waveform produced by the controller in FIG. 3A.

FIG. 3C is another example of a driving waveform produced by the controller in FIG. 3A.

FIG. 4 is a schematic diagram of light sources of a light source system being turned on at different timings according to a third embodiment of the disclosure.

FIG. 5 is a schematic view of a light source system according to a fourth embodiment of the disclosure.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

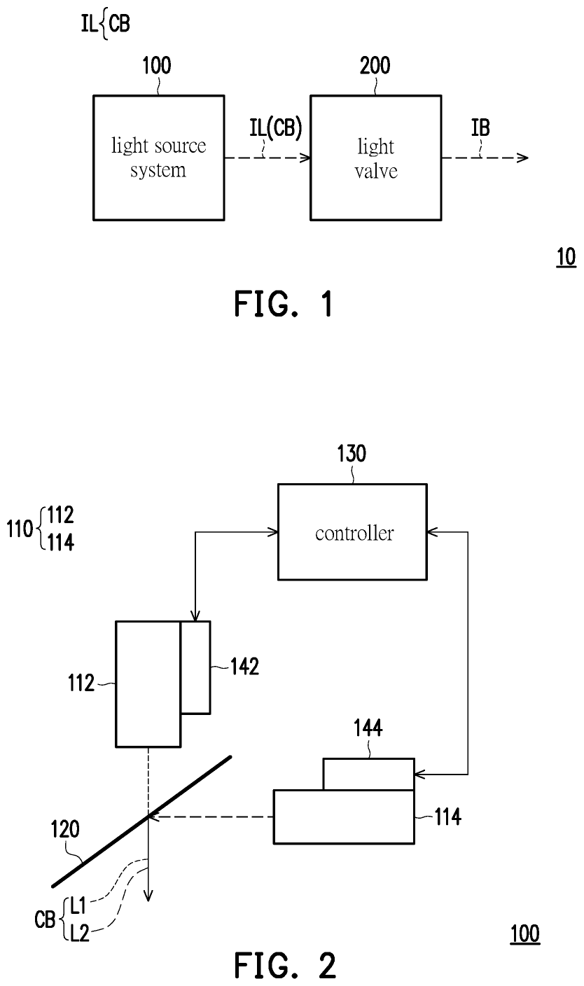

FIG. 1 is a schematic view of a display device according to an embodiment of the disclosure. Referring to FIG. 1, a display device 10 in this embodiment includes a light source system 100 and a light valve 200. The light source system 100 is configured to provide an illumination beam IL. The light valve 200 is disposed in a transmission path of the illumination beam IL and is configured to transform the illumination beam IL to an image beam IB.

In an embodiment, the display device 10 is a vehicle head-up display or a pico projector. However, the disclosure is not limited thereof.

In this embodiment, the light valve 200 could be a spatial light modulator, such as a digital micro-mirror device (DMD), a liquid-crystal-on-silicon panel (LCOS panel), and a liquid crystal panel (LCD). The disclosure does not limit the form and type of the light valve 200.

FIG. 2 is a schematic view of a light source system according to a first embodiment of the disclosure. In FIG. 2, the light source system 100 includes one light source module 110, but the number of light source module 110 should be based on the actual design. When the light source system 100 includes a plurality of light source modules 110, different light source modules could provide color beams CB with different light colors.

Referring to FIG. 2, in this embodiment, the light source system 100 includes at least one light source module 110. Each of light source module 110 is configured to emit a color beam CB and includes a plurality of light sources 112 and 114. The light sources 112 and 114 are, for example, laser light sources. Moreover, different light sources 112 and 114 are configured to emit excitation lights L1 and L2 of different wavelengths. The excitation lights L1 and L2 are combined to form the color beam CB. The color beam CB could be a red, green, blue beam or a combination thereof. The at least one color beam CB is combined to form the illumination beam IL. Differences in the wavelengths fall within a range of 5 nm to 10 nm.

In this embodiment, the light source system 100 further includes at least one light combining element 120. The light combining element 120 is, for example, a beam splitter. FIG. 2 illustrates that the excitation light L1 can penetrate the light combining element 120, and the light combining element 120 makes the excitation light L2 be reflected. Moreover, when the light source system 100 includes a plurality of light source modules 110, the light source system 100 could also include a plurality of light combining elements 120, and different light combining elements 120 are disposed on transmission paths of the excitation lights L1 and L2 emitted by corresponding light source modules 110 of the light combining elements 120.

In this embodiment, each of light combining element 120 is disposed on transmission paths of the excitation lights L1 and L2, wherein the excitation lights L1 and L2 form the color beam CB by the light combining element 120, and optical paths of the excitation lights L1 and L2 behind the light combining element 120 overlap to each other.

In this embodiment, the display device 10 further includes a controller 130. Each of light source module 110 includes at least one thermal-electric cooler 142 and 144 connected to at least one of the light sources 112 and 114 and electrically connected to the controller 130. FIG. 2 illustrates that the light source module 110 includes a plurality of thermal-electric coolers 142 and 144, and each light sources 112 and 114 is connected to one of the thermal-electric coolers 142 and 144. However, the disclosure is not limited thereof. In another embodiment, the number of thermal-electric coolers 142 and 144 may be less than the number of light sources 112 and 114. That is, some of the light sources 112 and 114 are not connected to thermal-electric coolers 142 and 144.

In this embodiment, the controller 130 controls a temperature of the at least one of the light sources 112 and 114 by the at least one thermal-electric cooler 142 and 144, so that a wavelength of the excitation light L1 and L2 emitted by the at least one of the light sources 112 and 114 is different from wavelengths of the excitation lights L1 and L2 emitted by other light sources 112 and 114.

In an embodiment, the controller 130 includes, for example, a central processing unit (CPU), a microprocessor, a digital signal processor (DSP), a programmable controller, a programmable logic device (PLD), or other similar devices, or a combination of the said devices, which are not particularly limited by the disclosure. Further, in an embodiment, each of the functions performed by the controller 130 may be implemented as a plurality of program codes. These program codes will be stored in a memory, so that these program codes may be executed by the controller 130. Alternatively, in an embodiment, each of the functions performed by the controller 130 may be implemented as one or more circuits. The disclosure is not intended to limit whether each of the functions performed by the controller 130 is implemented by ways of software or hardware.

Based on the foregoing, in an embodiment of the disclosure, the light source system 100 and the display device 10 using the light source system 100 includes at least one light source module 110, each of light source module 110 includes a plurality of light sources 112 and 114, different light sources 112 and 114 are configured to emit excitation lights L1 and L2 of different wavelengths, and differences in the wavelengths fall within a range of 5 nm to 10 nm. Since, the wavelength of each excitation light L1 and L2 has slightly difference to each other and different wavelengths of excitation lights L1 and L2 will generate different speckle patterns, the speckling effect of the combined color beam CB will be reduced. Moreover, when more light sources 112 and 114 is introduced in the light source system 100, the speckling effect of the light source system 100 will further be reduced, and the brightness of the illumination beam IL will also be increased. Furthermore, the condition of “the wavelengths fall within a range of 5 nm to 10 nm” helps to make the chromaticity between the excitation lights L1 and L2 difficult to be distinguished by the viewer, so that the color rendering effect of the color beam CB or the illumination beam IL is better.

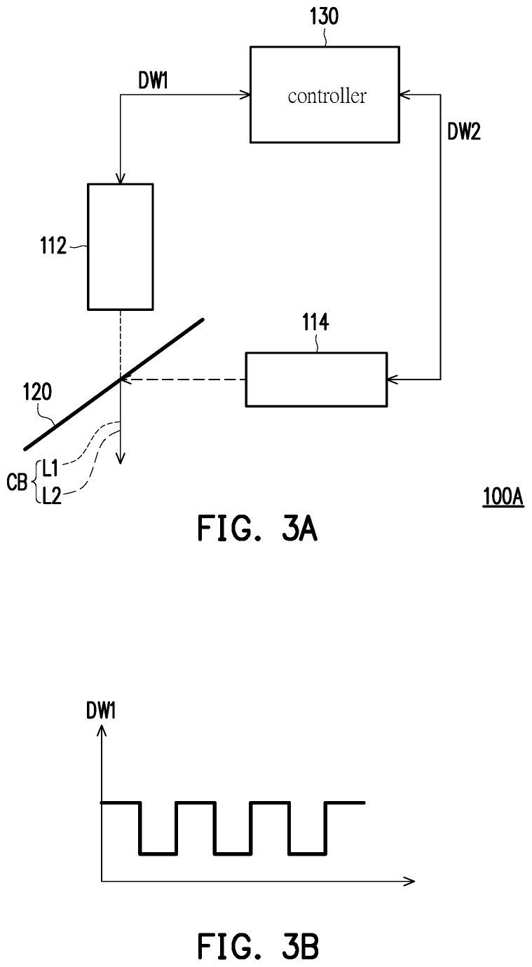

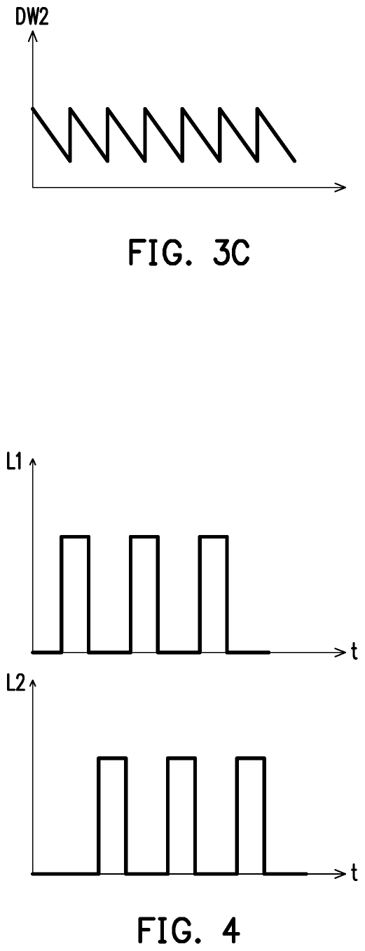

FIG. 3A is a schematic view of a light source system according to a second embodiment of the disclosure. FIG. 3B is an example of a driving waveform produced by the controller in FIG. 3A. FIG. 3C is another example of a driving waveform produced by the controller in FIG. 3A. Referring to FIGS. 3A to 3C, the light source system 100A of this embodiment is similar to the light source system 10 of FIG. 2, and the main difference therebetween is that the controller 130 outputs different driving waveforms DW1 and DW2 to the light sources 112 and 114, so that the light sources 112 and 114 are emitted the excitation lights L1 and L2 of the different wavelengths. That is, by using different driving waveforms DW1 and DW2 to control the light sources 112 and 114, the slight wavelength differences between the excitation lights L1 and L2 could be introduced. For example, FIG. 3B illustrates that the driving waveform DW1 is a square wave, and FIG. 3C illustrates that the driving waveform DW2 is a triangle wave (for example, a sawtooth wave).

FIG. 4 is a schematic diagram of light sources of a light source system being turned on at different timings according to a third embodiment of the disclosure. Referring to FIG. 4, the light source system of this embodiment is similar to the light source system 10 of FIG. 2, and the main difference therebetween is that the light sources 112 and 114 emit the excitation lights L1 and L2 in different timings. That is, different optical path of excitation lights L1 and L2 will also generate differences on speckle patterns. By sequentially switching on different light sources 112 and 114, the speckle pattern generated by each light source 112 and 114 could be averaged out. Moreover, by optimizing the timings when the light sources 112 and 114 are turned on, the de-speckling effect could also be optimized.

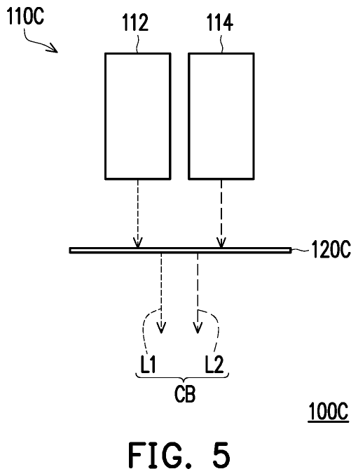

FIG. 5 is a schematic view of a light source system according to a fourth embodiment of the disclosure. Referring to FIG. 5, the light source system 100C of this embodiment is similar to the light source system 100 of FIG. 2, and the main difference therebetween is that the at least one light combining element 120C is lens array (for example, microlens array) and the light sources 112 and 114 of the each of light source module 110C are disposed side by side. That is, the lens array helps the optical paths between excitation lights L1 and L2 close to each other, so that the de-speckling effect is better.

Based on the foregoing, in an embodiment of the disclosure, the light source system and the display device using the light source system includes at least one light source module, each of light source module includes a plurality of light sources, different light sources are configured to emit excitation lights of different wavelengths, and differences in the wavelengths fall within a range of 5 nm to 10 nm. Since, the wavelength of each excitation light has slightly difference to each other and different wavelengths of excitation lights will generate different speckle patterns, the speckling effect of the combined color beam will be reduced.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

1. A light source system configured to provide an illumination beam, comprising:
a plurality of light source modules, all of the light source modules are configured to emit color beams of different wavelengths, each of the color beams has a narrow wavelength band and each of the light source modules comprises a plurality of excitation light sources, all of the excitation light sources of the each of the light source modules are configured to emit excitation lights of different wavelengths relative to each other,
wherein the excitation lights of the each of the light source modules are combined to form the color beam,
wherein a combination of all of the color beams form the illumination beam,
wherein the excitation light sources are laser light sources,
wherein differences in the wavelengths of the excitation lights emitted by all of the excitation light sources of the each of the light source modules fall within a range of 5 nm to 10 nm,
wherein one of the light source modules is configured to emit a red color beam, another one of the light source modules is configured to emit a green color beam, and yet another one of the light source modules is configured to emit a blue color beam.

2. The light source system according to claim 1, further comprising:
a controller,
wherein each of the light source modules comprises at least one thermal-electric cooler connected to at least one of the excitation light sources and electrically connected to the controller,
wherein the controller controls a temperature of the at least one of the excitation light sources by the at least one thermal-electric cooler, so that a wavelength of the excitation light emitted by the at least one of the excitation light sources is different from wavelengths of the excitation lights emitted by other excitation light sources, thereby all of the excitation light sources of the each of the light source modules are capable of emitting the excitation lights of the different wavelengths.

3. The light source system according to claim 1, further comprising:
a controller electrically connected to the excitation light sources, the controller outputs different driving waveforms to the excitation light sources, so that the excitation light sources are capable of emitting the excitation lights of the different wavelengths.

4. The light source system according to claim 1, wherein the excitation light sources are turned on in different timings, so that the excitation light sources emit the excitation lights in the different timings.

5. The light source system according to claim 1, further comprising:
a plurality of light combining elements, each of the light combining elements is disposed on transmission paths of the excitation lights, wherein the excitation lights of the each of the light source modules form the color beam by the light combining element, and optical paths of the excitation lights of the each of the light source modules downstream the light combining element overlap to each other.

6. The light source system according to claim 5, wherein
the light combining elements are lens arrays and the excitation light sources of the each of the light source modules are disposed side by side.

7. A display device configured to provide an image beam, comprising:
a light source system configured to provide an illumination beam; and
a light valve disposed in a transmission path of the illumination beam and configured to transform the illumination beam to the image beam,
wherein the light source system comprises a plurality of light source modules, all of the light source modules are configured to emit color beams of different wavelengths, each of the color beams has a narrow wavelength band and each of the light source modules comprises a plurality of excitation light sources, all of the excitation light sources of the each of the light source modules are configured to emit excitation lights of different wavelengths relative to each other,
wherein the excitation lights of the each of the light source modules are combined to form the color beam,
wherein a combination of all of the color beams form the illumination beam,
wherein the excitation light sources are laser light sources,
wherein differences in the wavelengths of the excitation lights emitted by all of the excitation light sources of the each of the light source modules fall within a range of 5 nm to 10 nm,
wherein one of the light source modules is configured to emit a red color beam, another one of the light source modules is configured to emit a green color beam, and yet another one of the light source modules is configured to emit a blue color beam.

8. The display device according to claim 7, further comprising:
a controller,
wherein each of the light source modules comprises at least one thermal-electric cooler connected to at least one of the excitation light sources and electrically connected to the controller,
wherein the controller controls a temperature of the at least one of the excitation light sources by the at least one thermal-electric cooler, so that a wavelength of the excitation light emitted by the at least one of the excitation light sources is different from wavelengths of the excitation lights emitted by other excitation light sources, thereby all of the excitation light sources of the each of the light source modules are capable of emitting the excitation lights of the different wavelengths.

9. The display device according to claim 7, further comprising:
a controller electrically connected to the excitation light sources, the controller outputs different driving waveforms to the excitation light sources, so that the excitation light sources are capable of emitting the excitation lights of the different wavelengths.

10. The display device according to claim 7, wherein the excitation light sources are turned on in different timings, so that the excitation light sources emit the excitation lights in the different timings.

11. The display device according to claim 7, wherein the light source system further comprising:
a plurality of light combining elements, each of the light combining elements is disposed on transmission paths of the excitation lights, wherein the excitation lights of the each of the light source modules form the color beam by the light combining element, and optical paths of the excitation lights of the each of the light source modules downstream the light combining element overlap to each other.

12. The display device according to claim 11, wherein the light combining elements are lens arrays and the excitation light sources of the each of the light source modules are disposed side by side.
